(19) United States
(12) Patent Application Publication
(10) Pub. No.: US 2005/0022135 A1
(43) Pub. Date: Jan. 27, 2005

(54) Systems and methods for window alignment grids

(76) Inventor: Abraham B. de Waal, San Jose, CA (US)

Correspondence Address: MOSER, PATTERSON & SHERIDAN L.L.P., 595 SHREWSBURY AVE, STE 100, FIRST FLOOR, SHREWSBURY, NJ, 07702, US

(21) Appl. No.: 10/626,011

(22) Filed: Jul. 23, 2003

(51) Int. Cl. G09G 5/00

(52) U.S. Cl. 715/788; 715/782; 715/798; 715/800

(57) ABSTRACT

A method of organizing at least one window on at least one computer monitor. The method comprises creating boundaries on the at least one computer monitor. The boundaries form at least one window area therebetween. At least one window area is associated with a window.

### FIELD OF THE INVENTION

Embodiments according to the present invention relate to organizing information on a computer monitor(s) and more particularly to window alignment grids.

### BACKGROUND

Many prior art computer systems exist that utilize a graphical user interface incorporating a desktop and windows metaphor and that include a single monitor. Although prevalent, these systems lack flexibility in how a user can automatically place and shape various windows. These single monitor systems also have a limited display area.

Some prior art systems include multi-monitor systems. These systems can often provide more display area for the placement of windows.

An example of a multi-monitor system is a two-monitor system. A prior art two-monitor system can be thought of as a two-by-one grid on a two screen-wide surface with each screen representing its own grid area. In operation, when a user maximizes a window (i.e., causes it to be enlarged to some predetermined size that is typically the maximum display area), the window automatically maximizes to the left or the right half of the combined display surface (i.e., the left or right screen) and not to the entire combined display surface. This is a default behavior that can be contemplated by the user when the user seeks to maximize a window.

Such default behaviors enhance user operation and productivity. Accordingly, it would be desirable to improve the ability to organize and shape windows automatically on a single- or multi-monitor system.

### SUMMARY

Various embodiments according to the present invention include systems and methods of organizing at least one window on at least one computer monitor. In one embodiment, a method comprises creating boundaries on the at least one computer monitor. The boundaries form at least one window area therebetween. At least one window area is associated with a window.

A system for organizing at least one window comprises a processor. At least one computer monitor is coupled to the processor. A user interface is coupled to the processor. The user interface is configured to receive input from a user and facilitate creating boundaries on the at least one computer monitor, the boundaries forming at least one window area therebetween. The user interface is further configured to facilitate associating the at least one window area with a window.

A computer-based display system comprises a user input element for enabling a user to define window areas on a display. The computer-based display system also comprises a processing element for causing at least one window to be displayed on the display. Window shape and window placement are dependent on the user-defined window area in which the window is positioned.

### BRIEF DESCRIPTION OF THE DRAWINGS

Accompanying drawing(s) show exemplary embodiment(s) in accordance with one or more aspects of the present invention; however, the accompanying drawing(s) should not be taken to limit the present invention to the embodiment(s) shown, but are for explanation and understanding only.

FIG. 1 is a schematic diagram of an exemplary embodiment of a two-monitor system with uniform boundaries in accordance with one or more aspects of the present invention.

FIG. 2 is a schematic diagram of an exemplary embodiment of a two-monitor system with miscellaneous boundaries in accordance with one or more aspects of the present invention.

FIG. 3 is a schematic diagram of the system of FIG. 2 showing various windows within window areas in accordance with one or more aspects of the present invention.

FIG. 4 is a schematic diagram of the system of FIG. 2 showing one exemplary use for function keys in accordance with one or more aspects of the present invention.

FIG. 5 is a flow diagram for a methodology in accordance with one or more aspects of the present invention.

FIG. 6 illustrates subsystems of an exemplary computer system for use with the present system.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

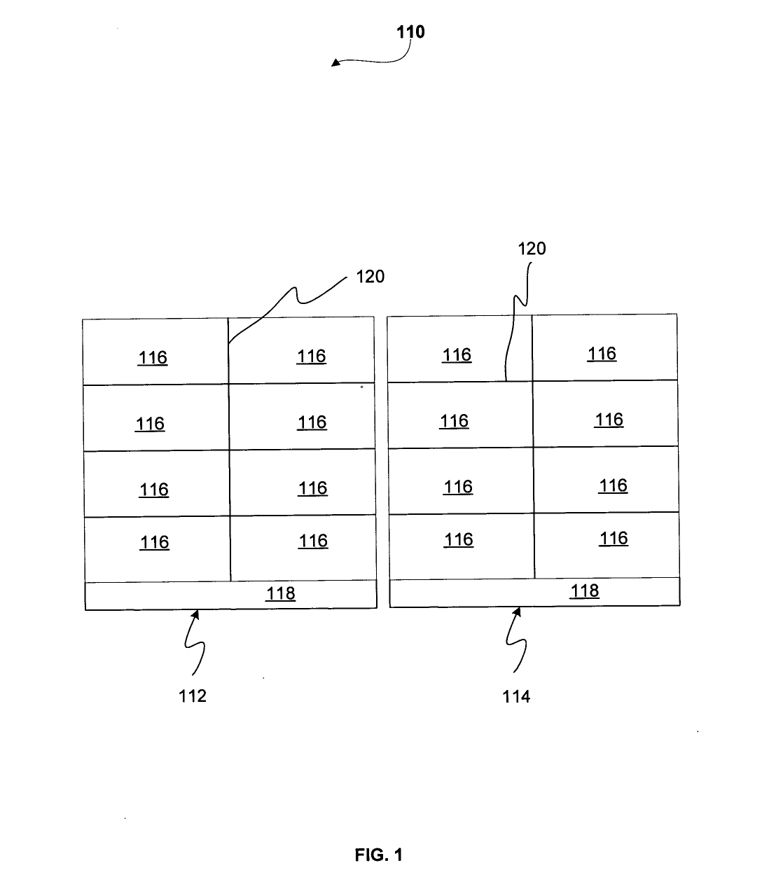

FIG. 1 is a schematic diagram of an exemplary embodiment of a two-monitor System generally designated 110. For purposes of illustration, only the computer monitor screens are depicted. A First Computer Monitor Screen 112 is placed next to a Second Computer Monitor Screen 114. System 110 allows a user to spread their work or other information across multiple computer monitor screens. Although System 110 comprises two computer monitors in this embodiment, it is contemplated that more or fewer computer monitors can be used in accordance with embodiments of the present invention. This setup can provide a user with an efficient way to manage multiple windows simultaneously with ease, thus increasing efficiency. Typically, System 110 also includes a processor, user interface (UI) and the like, discussed herein.

First Computer Monitor Screen 112 includes Window Areas 116 and a Minimized Window Area 118, discussed herein. The Window Areas 116 are defined by Boundaries 120. A user draws or otherwise creates Boundaries 120 via a UI. For example, the user uses a mouse to draw Boundaries 120. In another example, different boundary layout templates might be available from which the user can select using a mouse or keys. A user can either create and save boundary layout templates or choose from a list of predefined boundary layout templates. In FIG. 1, the user has created Boundaries 120 such that uniform rectangular Window Areas 116 are created.

Similarly, Second Computer Monitor Screen 114 includes Window Areas 116 and a Minimized Window Area 118. The Window Areas 116 are again defined by Boundaries 120 that the user has defined.

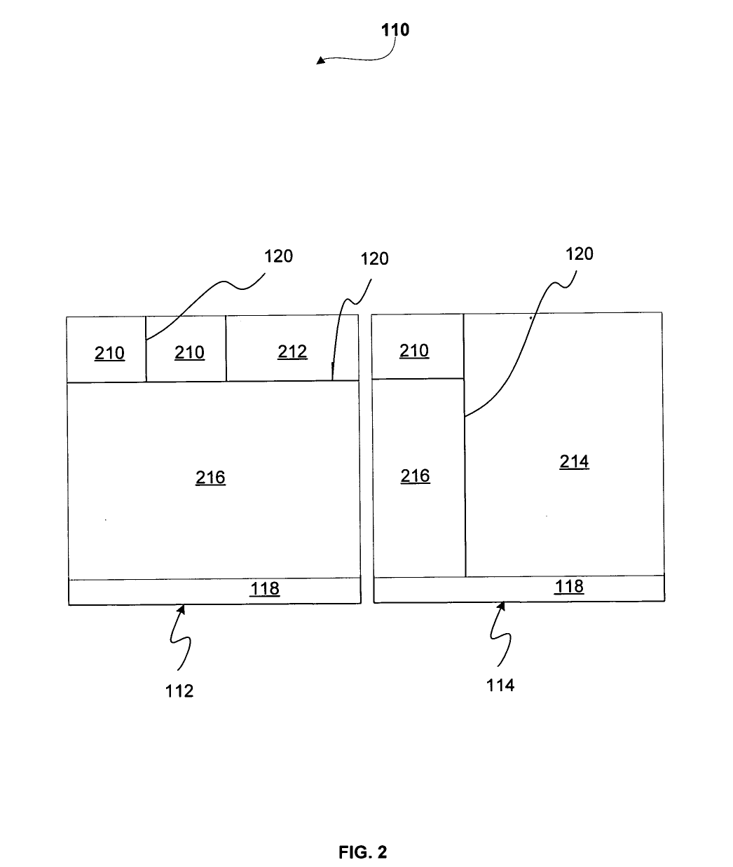

FIG. 2 is another schematic diagram of an exemplary embodiment of System 110. In this embodiment, the user has created miscellaneous Boundaries 120 in accordance with one or more aspects of the present invention. Boundaries 120 are not uniform in this embodiment.

In this embodiment, Boundaries 120 define three Window Areas 210 of the same size and shape. A Window Area 212 is slightly larger than a Window Area 210. A Window Area 214, in Second Computer Monitor Screen 114, is larger than and of a different shape than Window Areas 210 and 212. A Window Area 216 is the largest of the window areas in FIG. 2. It is noteworthy that Window Area 216 spans portions of First Computer Monitor Screen 112 and Second Computer Monitor Screen 114.

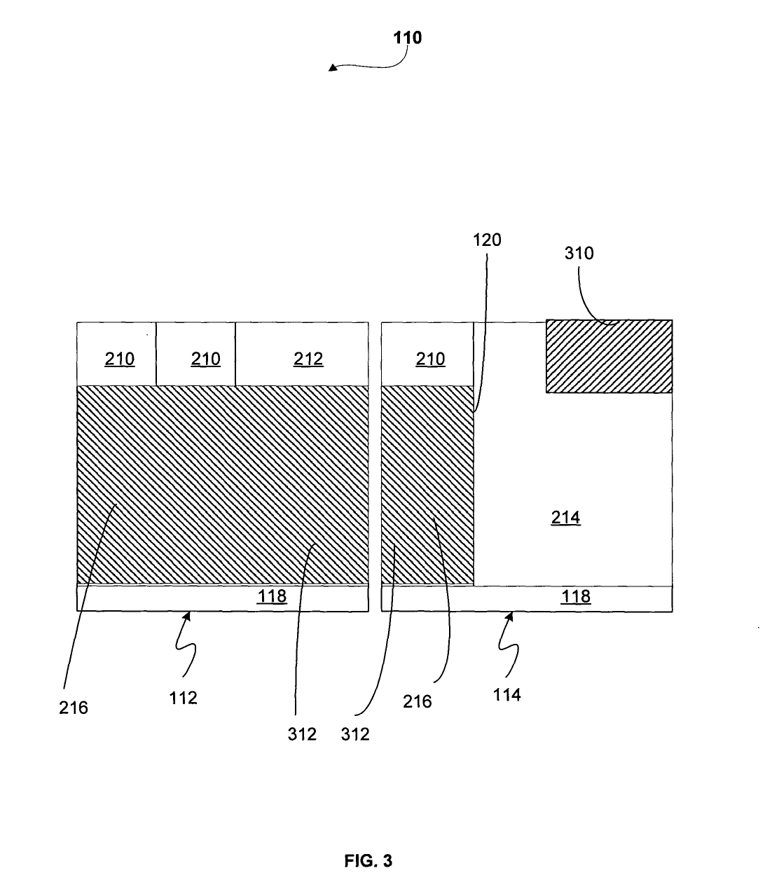

FIG. 3 is a schematic diagram of System 110 of FIG. 2 showing various windows within window areas in accordance with one or more aspects of the present invention. For example, a Window 310 resides within Window Area 214. Likewise, Window 312 resides within Window Area 216. Window 310 and a Window 312 can comprise an application, text or the like. Multiple windows can be contained within one window area.

In this illustrative example, Window 310 consumes a relatively small portion of Window Area 214. Window 310 has snapped to a corner of Window Area 214. Function keys on a computer keyboard or UI allow, in one embodiment, Window 310 to snap to an area of Window Area 214. Likewise, Window 310 can be snapped to Boundary 120, or any other desired boundary. This snapping can occur when the user activates a function key, when the user maximizes Window 310 from Minimized Window Area 118, when a user moves Window 310 proximate Boundary 120, or the like.

Likewise, a Window 312 has snapped to Window Area 216. In this case, the user has instructed, via a function key or the like, Window 312 to maximize and consume almost the entire area of Window Area 216. In another embodiment, the user instructs Window 312 to maximize to the entire area of Window Area 216. It is also noteworthy that when a user resizes a window, such as Window 312 for example, the window can also snap to one or more boundaries. The user can also activate a function key to instruct a window to snap to the closest intersection of two boundaries.

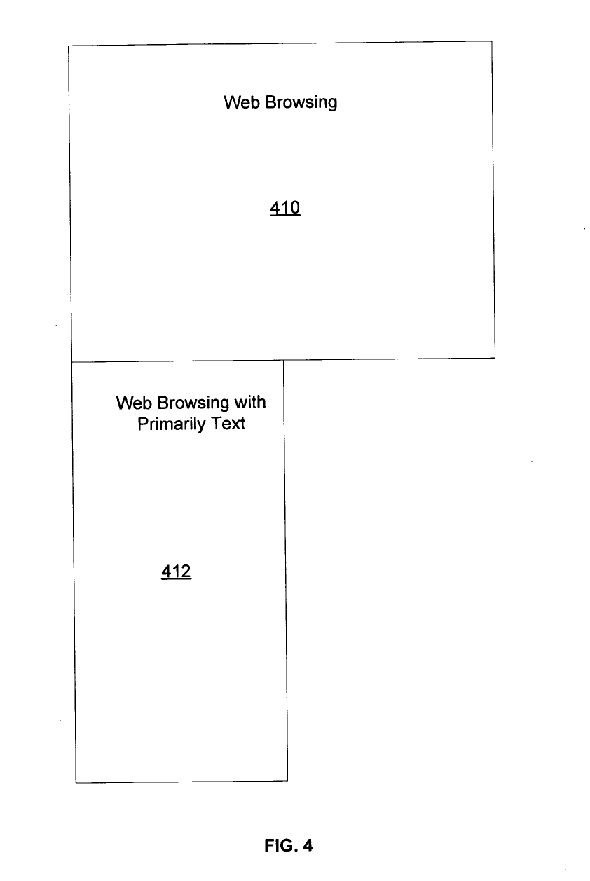

FIG. 4 is a schematic diagram of a portion of System 110 of FIG. 2 showing one exemplary use for function keys in accordance with one or more aspects of the present invention. Function keys can allow a user to instruct windows to snap to different window area layouts. In one embodiment, the function keys can actually be on a task bar or other area of a computer monitor screen, and activated via a mouse. In another example, a “maximize” icon or button can be used to instruct a window to maximize to a window area when the window is not already maximized. If the window is already maximized to a window area, the same icon or button can be used to instruct the window to maximize to an entire computer display or the like.

In this illustrative example, two window areas are shown. Window Area 410 is running a web browsing application. Web browsing applications often require a four-by-three aspect ratio of width to length for browsing most content. However, when a user is using a web browser to browse primarily text, the user might prefer a one-by-two aspect ratio to improve ease of reading. Therefore, the user can activate a function key and instruct the application to snap to Window Area 412 with such an aspect ratio. It is also envisioned that window areas can be created within window areas. Additionally, in one embodiment window areas overlap other window areas or windows.

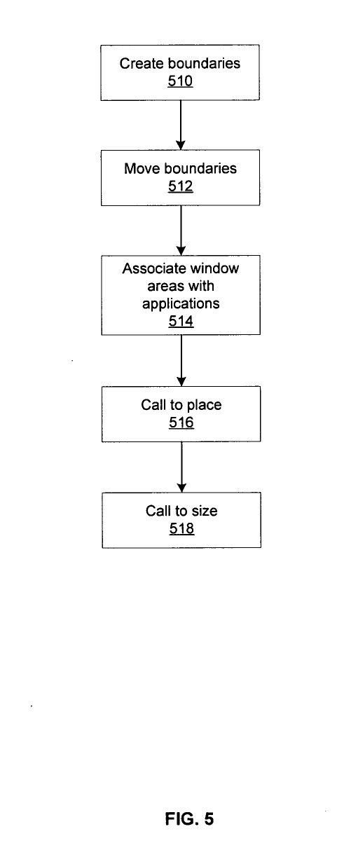

FIG. 5 is a flow diagram for a methodology in accordance with one or more aspects of the present invention. In step 510, a user creates boundaries using a UI and a mouse, for example. As mentioned herein, the boundaries can also be pre-made and selected from templates. It is contemplated that in some embodiments the boundaries are not straight lines.

In step 512, the user (if desired) moves the boundaries using the UI and mouse, for example. The user can thus adjust the size and shape of the window areas. After the user is satisfied with the window area layout defined by the boundaries, the user can save the layout.

In step 514, the user associates the window areas with various applications or the like. For example, the user associates the window areas with word processors, web browsers, spreadsheets and the like. The user can assign home window areas to windows so that the windows maximize to the same home window area all the time. The user can then save the association data if desired.

In step 516, the user performs an action, such as activating a function key or the like, causing a function call to place a selected window in a window area.

In step 518, the user again performs an action, such as activating a function key or the like, causing a function call to size the selected window in the window area. As discussed herein, the window may consume a portion or the whole of a given window area.

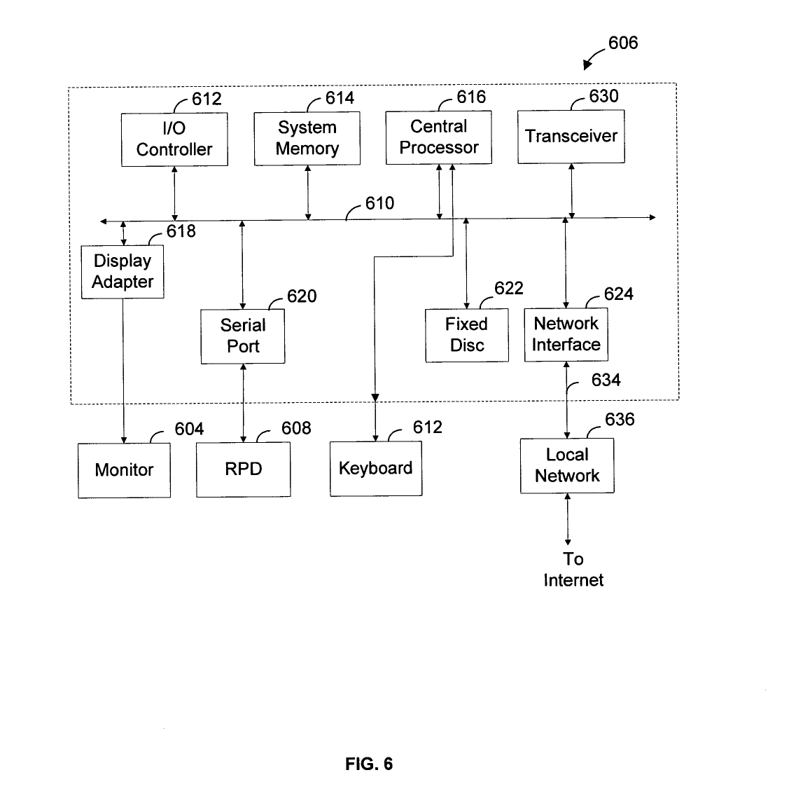

FIG. 6 illustrates subsystems found in one exemplary computer system, such as a Computer System 606, that can be used in accordance with embodiments of the present invention. Computers can be configured with many different hardware components and can be made in many dimensions and styles (e.g., laptop, palmtop, server, workstation and mainframe). Thus, any hardware platform suitable for performing the processing described herein is suitable for use with the present invention.

Subsystems within Computer System 606 are directly interfaced to an Internal Bus 610. The subsystems include an Input/Output (I/O) Controller 612, a System Random Access Memory (RAM) 614, a Central Processing Unit (CPU) 616, a Display Adapter 618, a Serial Port 620, a Fixed Disc 622 and a Network Interface Adapter 624. The use of Bus 610 allows each of the subsystems to transfer data among the subsystems and, most importantly, with CPU 616. External devices can communicate with CPU 616 or other subsystems via Bus 610 by interfacing with a subsystem on Bus 610.

FIG. 6 is merely illustrative of one suitable configuration for providing a system in accordance with the present invention. Subsystems, components or devices other than those shown in FIG. 6 can be added without deviating from the scope of the invention. A suitable computer system can also be achieved without using all of the subsystems shown in FIG. 6. Other subsystems such as a CD-ROM drive, graphics accelerator, etc., can be included in the configuration without affecting the performance of Computer System 606.

One embodiment according to the present invention is related to the use of an apparatus, such as Computer System 606, for implementing a system according to embodiments of the present invention. CPU 616 can execute one or more sequences of one or more instructions contained in System RAM 614. Such instructions may be read into System RAM 614 from a computer-readable medium, such as Fixed Disc 622. Execution of the sequences of instructions contained in System RAM 614 causes CPU 616 to perform process steps, such as the process steps described herein. One or more processors in a multi-processing arrangement may also be employed to execute the sequences of instructions contained in the memory. In alternative embodiments, hard-wired circuitry may be used in place of or in combination with software instructions to implement the invention. Thus, embodiments of the invention are not limited to any specific combination of hardware circuitry and software.

The terms “computer-readable medium” and “computer-readable media” as used herein refer to any medium or media that participate in providing instructions to CPU 616 for execution. Such media can take many forms, including, but not limited to, non-volatile media, volatile media and transmission media. Non-volatile media include, for example, optical or magnetic discs, such as Fixed Disc 622. Volatile media include dynamic memory, such as System RAM 614. Transmission media include coaxial cables, copper wire and fiber optics, among others, including the wires that comprise one embodiment of Bus 610. Transmission media can also take the form of acoustic or light waves, such as those generated during radio frequency (RF) and infrared (IR) data communications. Common forms of computer-readable media include, for example, a floppy disc, a flexible disc, a hard disc, magnetic tape, any other magnetic medium, a CD-ROM disc, digital video disc (DVD), any other optical medium, punch cards, paper tape, any other physical medium with patterns of marks or holes, a RAM, a PROM, an EPROM, a FLASHEPROM, any other memory chip or cartridge, a carrier wave, or any other medium from which a computer can read.

Various forms of computer-readable media may be involved in carrying one or more sequences of one or more instructions to CPU 616 for execution. Bus 610 carries the data to System RAM 614, from which CPU 616 retrieves and executes the instructions. The instructions received by System RAM 614 can optionally be stored on Fixed Disc 622 either before or after execution by CPU 616.

Therefore, methods and systems for organizing information on a single or multi-monitor system have been shown and described. Methods and systems described herein allow for window alignment boundaries (e.g., window alignment grids or the like) of various shapes and sizes to be created and associated with various applications.

While the foregoing is directed to embodiments in accordance with one or more aspects of the present invention, other and further embodiments of the present invention may be devised without departing from the scope thereof, which is determined by the claims that follow. For example, it is noteworthy that although embodiments according to the present invention have been described within the context of rectangular windows and window areas, they are not limited to rectangular shapes. Claims listing steps do not imply any order of the steps unless such order is expressly indicated.

1. A method of organizing at least one window on at least one computer monitor, the method comprising:
creating boundaries on the at least one computer monitor, the boundaries forming at least one window area therebetween; and
associating the at least one window area with a window.

2. The method of claim 1, wherein the window comprises an application.

3. The method of claim 1, wherein the window comprises text.

4. The method of claim 1, further comprising placing the window in an at least one window area associated therewith.

5. The method of claim 1, further comprising sizing the window in an at least one window area associated therewith.

6. The method of claim 1, further comprising moving at least one boundary.

7. The method of claim 1, further comprising adjusting a size of a window area.

8. The method of claim 1, further comprising adjusting a shape of a window area.

9. The method of claim 1, wherein at least one of the window areas spans a plurality of monitors.

10. A system for organizing at least one window, the system comprising:
a processor;
at least one computer monitor coupled to the processor; and
a user interface coupled to the processor, the user interface configured to receive input from a user and facilitate creating boundaries on the at least one computer monitor, the boundaries forming at least one window area therebetween,
the user interface further configured to facilitate associating the at least one window area with a window.

11. The system of claim 10, wherein a window comprises an application.

12. The system of claim 10, wherein a window comprises text.

13. The system of claim 10, wherein a window is located in an at least one window area associated therewith.

14. The system of claim 10, wherein a size of at least one window area is adjustable.

15. The system of claim 10, wherein a shape of at least one window area is adjustable.

16. The system of claim 10, wherein at least one of the window areas spans a plurality of computer monitors.

17. A computer-readable media for storing software instructions which when executed by a processor perform the steps of:
creating boundaries on at least one computer monitor, the boundaries forming at least one window area therebetween; and
associating the at least one window area with a window.

18. The computer-readable media of claim 17, wherein the window comprises an application.

19. The computer-readable media of claim 17, wherein the window comprises text.

20. The computer-readable media of claim 17, wherein the processor further performs the step of placing the window in an at least one window area associated therewith.

21. The computer-readable media of claim 17, further comprising sizing the window in an at least one window area associated therewith.

22. The computer-readable media of claim 17, wherein the processor further performs the step of moving at least one boundary.

23. The computer-readable media of claim 17, wherein the processor further performs the step of adjusting a size of a window area.

24. The computer-readable media of claim 17, wherein the processor further performs the step of adjusting a shape of a window area.

25. The computer-readable media of claim 17, wherein at least one of the window areas spans a plurality of monitors.

26. A system for organizing at least one window on at least one computer monitor, the system comprising:
means for creating boundaries on the at least one computer monitor, the boundaries forming at least one window area therebetween; and
means for associating the at least one window area with a window.

27. A computer-based display system, comprising:
a user input element for enabling a user to define window areas on a display; and
a processing element for causing at least one window to be displayed on the display, wherein window shape and window placement are dependent on the user-defined window area in which the window is positioned.

28. The system of claim 27, wherein a window comprises an application.

29. The system of claim 27, wherein a window comprises text.

30. The system of claim 27, wherein a size of at least one window area is adjustable.

31. The system of claim 27, wherein a shape of at least one window area is adjustable.

32. The system of claim 27, wherein at least one of the window areas spans a plurality of displays.
